(19) United States
(12) Patent Application Publication
(10) Pub. No.: US 2008/0290181 A1
(43) Pub. Date: Nov. 27, 2008

(54) System and method for calculating a foreign exchange index

(76) Inventors: Edoardo Dimitri, London (GB); Philippos Kassimatis, London (GB); Andrew Kaufmann, London (GB)

Correspondence Address: AMSTER, ROTHSTEIN & EBENSTEIN LLP, 90 PARK AVENUE, NEW YORK, NY, 10016, US

(21) Appl. No.: 11/805,958

(22) Filed: May 24, 2007

(51) Int. Cl. G06C 29/00; G06Q 40/00

(52) U.S. Cl. 235/61 PD; 705/35

(57) ABSTRACT

A method for calculating a foreign exchange index including the steps of: retrieving currency exchange rates corresponding to a plurality of currencies; adjusting long positions and short positions in the plurality of currencies based on an optimization algorithm; and generating the index based on the results of the adjusting step. The foreign exchange index may be calculated on a periodic basis using an optimization model implemented via a computer program, and may be used as a benchmark for a variety of financial products.

### FIELD OF THE INVENTION

The present invention generally relates to systems and methods for calculating an index based on a carry trade strategy for a plurality of foreign currencies. The present invention also relates to financial products which use the index as a benchmark.

### BACKGROUND OF THE INVENTION

Over the last decade, currency exchange markets have attained record-breaking volumes. As these markets have grown, investors have formulated strategies for maximizing yield. One such strategy exploits extended periods of exchange rate appreciation by higher yielding currencies, known as “forward bias”, by investing in these high-yielding currencies. A popular form of this investment strategy is the carry trade, in which an investor takes a short position by borrowing in a low-interest rate currency, such as the U.S. dollar, and then takes a long position in a higher interest rate currency, such as the Australian dollar. With a carry trade, an investor essentially bets that the exchange rate will not change so as to offset the interest rate differential.

With the carry trade strategy, the investor takes a risk that the interest rate differential will be offset by a change in interest rates, which would result in the investor possibly having to pay back more than the investor earned. Thus, investors tend to gravitate towards this type of strategy as long as there are interest rate differentials and during extended trends in exchange rates that encourage speculative strategies. However, when these conditions weaken, ineffectiveness of strategies such as the carry trade results in diminishment of the currency exchange market.

Accordingly, there is a need for an investment strategy in currency exchange markets that applies risk control measures while still providing the advantages in yield offered by carry trading.

### SUMMARY OF THE INVENTION

A method for calculating a foreign exchange index according to an exemplary embodiment of the present invention comprises the steps of: retrieving currency exchange rates corresponding to a plurality of currencies; adjusting long positions and short positions in the plurality of currencies based on an optimization algorithm; and generating the index based on the results of the adjusting step.

In at least one embodiment, the step of adjusting comprises assigning weights to the plurality of currencies based on the optimization algorithm, where each weight represents a position taken in a corresponding currency.

In at least one embodiment, a positive weight signifies an investment and a negative weight signifies a borrowing.

In at least one embodiment, the weights are within a range of +100% to −100%.

In at least one embodiment, the sum of all positive weights is less than or equal to 100%.

In at least one embodiment, the sum of all positive weights is less than or equal to 200%.

In at least one embodiment, the sum of all positive weights is less than or equal to 50%.

In at least one embodiment, the sum of all positive weights is unlimited.

In at least one embodiment, the generated index is expressed in one of the plurality of currencies.

In at least one embodiment, the generated index is expressed in a currency that is not one of the plurality of currencies.

In at least one embodiment, at least one of the following benchmarks is used as a bench mark for the currency exchange rates: ECB37, Federal Reserve Bank of New York 10 am Rates (1FED), Federal Reserve Bank of New York 10 am Rates (1FEE), and rates published by the WM Company.

In at least one embodiment, the optimization algorithm is a mean-variance optimization algorithm.

In at least one embodiment, the mean-variance algorithm comprises one or more constraints.

In at least one embodiment, the one or more constraints comprise a predetermined target volatility.

In at least one embodiment, the target volatility is 5%.

In at least one embodiment, the target volatility is 1%.

In at least one embodiment, the target volatility is 10%.

In at least one embodiment, the target volatility is within a range of 0% to 30%.

In at least one embodiment, the adjusting step comprises maximizing expected return based on the target volatility using the optimization algorithm.

In at least one embodiment, the one or more constraints comprise a predetermined target return.

In at least one embodiment, the target return is within a range of 0% to 20%.

In at least one embodiment, the adjusting step comprises minimizing expected volatility based on the target return using the optimization algorithm.

In at least one embodiment, the predetermined target return is based on one or more of the following: 12-month LIBOR rates, 1-month LIBOR rates, 3-month LIBOR rates, 6-month LIBOR rates, 1-week LIBOR rates, and any officially published interest rate for that currency.

In at least one embodiment, the one or more constraints comprise a variance-covariance matrix.

In at least one embodiment, the variance-covariance matrix is calculated using historical data.

In at least one embodiment, the historical data is historical periodic log-returns for each of the one or more currencies over a rolling periodic window.

In at least one embodiment, a period for the rolling periodic window is one of the following: a business day, a calendar day, one week, one month, three months, six months, one year, 18 months, 2 years and 3 years.

In at least one embodiment, the variance-covariance matrix is calculated using weightings for each periodic log-return that decrease over time with an exponential formula.

In at least one embodiment, the variance-covariance matrix is calculated using a GARCH (Generalized AutoRegressive Conditional Heteroskedasticity) model.

In at least one embodiment, the variance-covariance matrix is calculated using volatilities implied by quoted relative options.

In at least one embodiment, the step of adjusting is performed on a periodic basis.

In at least one embodiment, the periodic basis is at least once a month.

In at least one embodiment, the periodic basis is at least once a week.

In at least one embodiment, the periodic basis is at least once a year.

In at least one embodiment, the one or more currencies are selected from a group consisting of United States Dollars, Euros, Japanese Yen, Canadian Dollars, Swiss Francs, British Pounds, Australian Dollars, New Zealand Dollars, Norwegian Krone and Swedish Krona.

In at least one embodiment, the step of retrieving comprises selecting at least one of the one or more currencies for retrieval based on specific criteria.

In at least one embodiment, the specific criteria is at least one of the following: potential for investment, geographical location, deliverability, and whether the currency is free-floating.

In at least one embodiment, the specific criteria is potential for investment, the potential for investment being based on liquidity of the at least one of the one or more currencies.

In at least one embodiment, the one or more currencies are investable assets.

A financial product according to an exemplary embodiment of the present invention uses a foreign exchange index calculated using the above-described method as one of one or more benchmarks.

In at least one embodiment, the financial product is a fund.

In at least one embodiment, the fund is exchange traded.

In at least one embodiment, the financial product is a note.

In at least one embodiment, the note is exchange traded.

In at least one embodiment, the financial product is a security.

In at least one embodiment, the financial product is a debt instrument.

In at least one embodiment, the financial product is an OTC (Over-The-Counter) product.

A method of calculating a foreign exchange index according to an exemplary embodiment of the present invention comprises the steps of: selecting a plurality of currencies for inclusion in the index; selecting a benchmark for the index; applying an overlay allocation to the benchmark, the overlay allocation being based on adjusting long positions and short positions in the plurality of currencies based on an optimization algorithm; and generating the index based on the results of the applying step.

A computer-based system for calculating a foreign exchange index according to an exemplary embodiment of the present invention comprises a memory unit for storing information regarding the index, a computer-readable medium comprising a model analyzer that generates a first set of instruction for adjusting long positions and short positions in the one or more currencies based on an optimization algorithm using currency exchange rates corresponding to the one or more currencies; and an index calculator that generates a second set of instructions for generating the index based on the adjustment performed by the model analyzer, and a processor that executes the first and second set of instructions.

According to an exemplary embodiment of the present invention, a computer readable medium has instructions executable on a processor for performing a method for calculating a foreign exchange index, the method comprising the steps of: retrieving currency exchange rates corresponding to a plurality of currencies; adjusting long positions and short positions in the plurality of currencies based on an optimization algorithm; and generating the index based on the results of the adjusting step.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 is a flow chart showing a method for calculating a foreign exchange index according to an exemplary embodiment of the present invention;

FIG. 2 is a block diagram showing a system for calculating a foreign exchange index according to an exemplary embodiment of the present invention; and

FIG. 3 is a timeline showing the steps involved in periodically calculating an index according to an exemplary embodiment of the present invention.

### DETAILED DESCRIPTION OF PREFERRED EMBODIMENTS

Various exemplary embodiments of the present invention are directed to a system and method for determining an investment strategy based on a carry trade strategy for a range of liquid foreign currencies. The investment strategy can be used to generate an index which can be used as a benchmark for a wide variety of financial products. The present invention combines representative benchmark investment with a strategy that can provide additional returns through an objective systematic methodology that considers historical data to optimize the possibility of additional returns. In particular, the system and method according to various exemplary embodiments of the present invention uses a quantitative approach to determine an index composition, as described in further detail below.

The index according to the present invention may be made up of a number of index constituents. For example, each index constituent of the index may be a cash settled forward rate agreement in one of a variety of currencies. Preferably, the index includes ten index constituents of cash settled forward rate agreements denominated in EUR, USD, GBP, CHF, JPY, NZD, AUD, SEK, NOK and CAD. However, any other number and variety of currencies may be used. The selection of currencies for inclusion in the index may be based on specific criteria, such as, for example, potential for investment, which may in turn be based on liquidity of the currency. Other criteria used to select the currencies include geographical location (e.g., the index may be restricted to currencies from Latin America, North America, Eastern Europe, Asia. etc.), deliverability (e.g., EUR, USD and HUF are deliverable, while CNY is non-deliverable), whether the currency is free-floating (e.g., EUR ad USD are free-floating, while CNY is managed floating), and any other subjective or objective criteria.

According to a method for generating the index of an exemplary embodiment of the invention, a systematic mean optimizer model is run to determine the core weights of each of the forward rate agreements in the index. The mean optimizer model may determine a “model portfolio” based on pre-defined risk and return parameters, and generates buy or sell signals based on the relative position of index constituents. The model preferably allocates a greater weight to the constituents with a high yield and tends to allocate a negative weight to the constituents with a low yield. The weights assigned to each constituent is preferably restricted to a particular range, for example, a range of −100% to +100%, so that the sum of the weights is equal to zero. A positive weight implies an investment in the constituent while a negative weight corresponds to borrowing in that constituent. The model may be run on a periodic bases, for example, at a monthly or weekly basis, to determine the optimal allocation. In this regard, a computer program may be used to solve the model to generate an updated index on a periodic basis.

The model used in the present invention may use a variety of pre-defined risk and return parameters. For example, a pre-defined risk level may be set at a particular percentage representing the expected yearly standard deviation of the aggregate returns of the allocation in the index constituents. The pre-defined risk level may be set at, for example, 1%, 5%, or 10%, and is preferably set at a level within a range of 0% to 30%. The return parameters may be based on, for example, historical correlation of returns between each pair of constituents, historical standard deviation of returns of each of the constituents, and the expected return for each of the constituents taken as the interbank rate over a period of time (e.g., 12 months) multiplied by the appropriate base. For example, the expected return of each currency may be, for example, 12-month LIBOR (London Interbank Offered Rate) rates, 1-month LIBOR rates, 3-month LIBOR rates, 6-month LIBOR rates, 1-week LIBOR rates, any officially published interest rate for that currency, or any reference interest rate provided by the present index generating system or by third party providers. These return parameters are preferably updated each time the model is used to calculate the weights for each constituent.

According to an exemplary embodiment of the present invention, the model used to optimize the constituents of the index may be based on “mean-variance optimization”, introduced by Harry M. Markowitz in 1952. The mean variance optimization algorithm aims at maximizing the portfolio return for a given level of risk, and requires three inputs: expected returns, expected volatility and expected correlation. Using mean variance optimization, the optimal weights for index constituents may be determined mathematically using equation (1) shown below:

$$Maximize ( {\sum }_{i = 1}^{10} {w}_{i , R} \times {YR}_{i , R} \times \frac{365}{{Base}_{i}} ) \qquad ( 1 )$$

subject to the following conditions:

$$\begin{matrix}( a ) & \begin{matrix}\sqrt{{\sum }_{j = 1}^{10} {\sum }_{i = 1}^{10} {σ}_{i , R} \times {Corr}_{R} ( i , j ) \times {σ}_{j , R} \times {w}_{i , R} \times {w}_{j , R}} \leq \\ desired risk ( e . g . , 5 \% )\end{matrix} \\ ( b ) & {\sum }_{i = 1}^{10} {w}_{i , R} = 0 \\ ( c ) & {w}_{i , R} \geq {w}_{i , R}^{l} and {w}_{i , R} \leq {w}_{i , R}^{u} for each i from 1 to 10\end{matrix}$$

where:

R=rebalancing date, occurring periodically (e.g., monthly);

W_{i,R}=weight at the rebalancing date of each of the constituents;

YR_{i,R}=12 month interest rate of each of the constituents;

Corr(i,j)=12 month historical correlation of returns between each pair of the constituents, calculated as the correlation between daily log returns;

σ_{i,R}=12 month historical standard deviation of each of the constituents, calculated as the standard deviation of daily log returns, multiplied by square root of 252;

W_{i,R}^{l}=minimum weight at the rebalancing date of each of the constituents; and

W_{i,R}^{u}=maximum weight at the rebalancing date of each of the constituents.

The matrix σ_{i,R}, also known as the variance-covariance matrix, in equation (1) is calculated using historical data. However, the variance-covariance matrix may also be calculated using weightings for each periodic log-return that decrease over time with an exponential formula, by using the GARCH (Generalized AutoRegressive Conditional Heteroskedasticity) model, which assumes that the current variance-covariance of the assets is a function of the variances-covariances of the assets at previous time periods, by using volatility implied by the relative options quoted in the market, or by using any other suitable calculation method.

It should be appreciated that the various exemplary embodiments of the present invention are not limited to the use of mean-variance optimization, and any other suitable optimization algorithm may be used, such as, for example, block optimization. Further, additional constraints may be placed on the algorithm, such as, for example, timing of reweighting of the constituents, and restriction of the sum of the positive weights to a specific percentage, such as limiting the sum of the positive weights to be no grater than 100%, 200%, 50% or any other percentage. The sum of the positive weights may also be unlimited. The algorithm could also be used to minimize volatility by entering a target return and optimizing the weighting of constituents, rather than maximizing profits with a target volatility. For example, a target return within a range of 0% to 20% may be input to the algorithm.

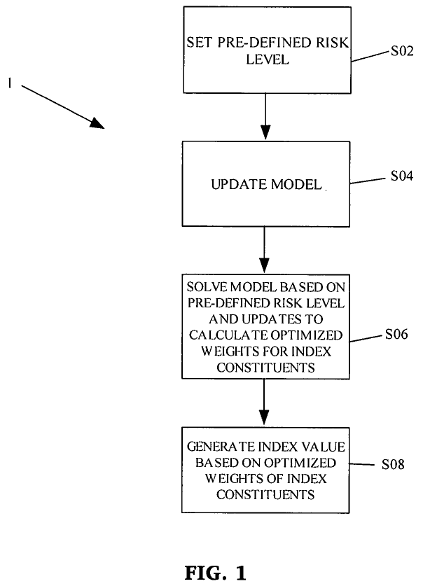

FIG. 1 is a flow chart showing a method of generating a foreign exchange index using a carry trade strategy, generally designated by reference number 1, according to an exemplary embodiment of the present invention. In step S02 of the method 1, the risk level is set at a desired level, for example, 5%. In step S04, the model used to assign weights to the various constituents of the index is updated as of the rebalancing date. For example, if using the mean variance optimization model as explained above, on the rebalancing date, the model is updated with historical correlation of returns between constituent pairs, historical standard deviation of returns of each of the constituents, and the expected return for each of the constituents taken as a periodic interbank rate multiplied by the appropriate base.

In step S06 of the method 1, the weighting model is solved using the pre-defined risk level and the updates to calculate optimized weights for the index constituents. In step S08, the intelligent carry index value is generated using the constituents weighted based on the results calculated in step S06.

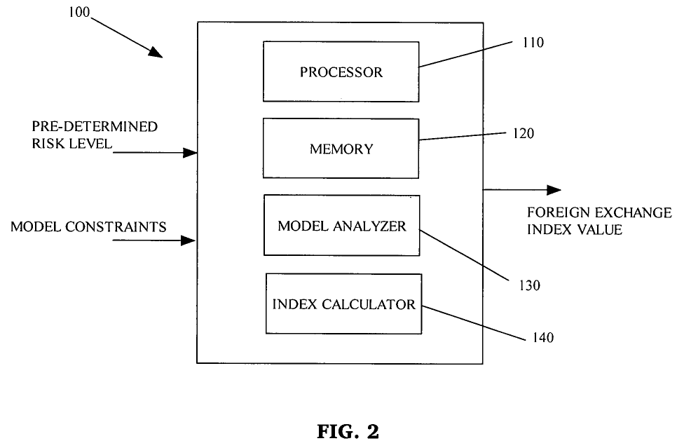

FIG. 2 is a block diagram showing a system for calculating a foreign exchange index, generally designated by reference number 100, according to an exemplary embodiment of the present invention. The system 100 includes a processor 110, a memory unit 120, a model analyzer 130 and an index calculator 140. The model analyzer 120 and index calculator 140 may be software components running on the processor 110, or separate hardware components of a computer system. Further, the system 100 may include more than one processor and the one or more processors may be disposed at a location remote from the other components of the system 100. The system 100 takes as input a predetermined risk level (e.g., 5%) and model constraints, such as, for example, interest rate of each of the constituents over a periodic rolling window, historical correlation of returns between each pair of the constituents over a periodic rolling window, and historical standard deviation of each of the constituents over a periodic rolling window. The period used for the rolling window may be, for example, one week, one month, three months (quarterly), six months, one year, 18 months, 2 years and 3 years. The model analyzer 130 uses the inputs to calculate optimized weights for the constituents of the foreign exchange index, and the index calculator 140 generates an index using the optimized weighting. The generated index is then output from the system 100. The index may be generated in one of the currency denominations of the constituents or any other currency denomination. The generated index may be used as a benchmark for a variety of financial products, such as, for example, a fund, a note, a security, a debt instrument or an OTC (Over-The-Counter) product.

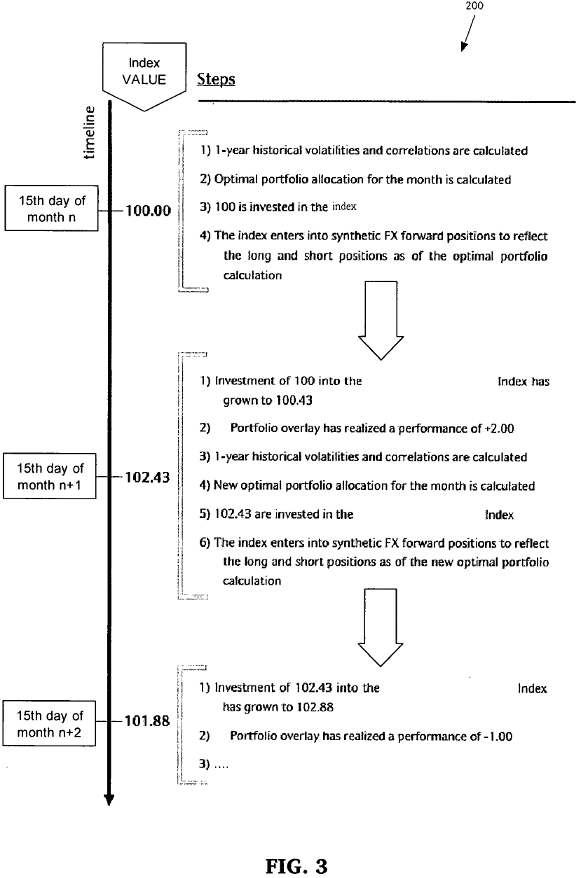

FIG. 3 is a timeline, generally designated by reference number 200, showing the steps involved in periodically calculating an index according to an exemplary embodiment of the present invention. In the timeline 200, the optimal portfolio calculation for the index is performed on the 15^{th} day of each month. However, it should be appreciated that this calculation may be performed on any other periodic basis, such as, for example, weekly or daily. With each reinvestment in the index, synthetic forward positions are entered to reflect the long and short positions as of the new optimal portfolio calculation. In particular, on the first recalculation date 210, a first step is performed in which 1-year historical volatilities and correlations are calculated, and as a second step these values are used as input to the optimization model to determine the optimal portfolio allocation for the month. In the third step performed on the recalculation date 210, as an example, 100 is invested in the index, where the 100 may be in any currency denomination (e.g., U.S. Dollars, Euros, Japanese Yen, etc.). In this case, the basis of the index is 100, so that at each subsequent recalculation date, the value of the index varies around this basis value. In the fourth step, the index enters into synthetic foreign exchange forward positions to reflect the long and short positions as of the new optimal portfolio calculation.

On the second recalculation date 220, a first step is performed in which it is determined how much the investment in the index has grown since the last recalculation date. As an example, the timeline 200 shows that the 100 invested has grown to 100.43. In step 2 of the second recalculation date, the realized performance of the index overlay is determined. The index overlay in this case are the synthetic forward positions based on the previous optimal portfolio calculation, which in this example has realized a performance of +2.00. In step 3, 1-year historical volatilities and correlations are again calculated, and in step 4, a new optimal portfolio allocation for the month is calculated using the optimization model. In step 5, an amount equivalent to the investment growth plus the amount realized by the index overlay is reinvested in the index, which amount is also taken as the new value for the index. In step 6, the index enters in synthetic foreign exchange forward positions to reflect the long and short positions as of the new optimal portfolio calculation. As shown in the timeline 200 at the third recalculation date 230, the process then iterates through the same steps at each subsequent recalculation date to determine the amount to reinvest based on investment growth and the amount realized by the index overlay, and then reinvests that amount based on the new optimal portfolio calculated using historical volatilities and correlations.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for calculating a foreign exchange index comprising:
retrieving currency exchange rates corresponding to a plurality of currencies;
adjusting long positions and short positions in the plurality of currencies based on an optimization algorithm; and
generating the index based on the results of the adjusting step.

2. The method of claim 1, wherein the step of adjusting comprises assigning weights to the plurality of currencies based on the optimization algorithm, where each weight represents a position taken in a corresponding currency.

3. The method of claim 2, wherein a positive weight signifies an investment and a negative weight signifies a borrowing.

4. The method of claim 2, wherein the weights are within a range of +100% to −100%.

5. The method of claim 2, wherein the sum of all positive weights is less than or equal to 100%.

6. The method of claim 2, wherein the sum of all positive weights is less than or equal to 200%.

7. The method of claim 2, wherein the sum of all positive weights is less than or equal to 50%.

8. The method of claim 2, wherein the sum of all positive weights is unlimited.

9. The method of claim 1, wherein the generated index is expressed in one of the plurality of currencies.

10. The method of claim 1, wherein the generated index is expressed in a currency that is not one of the plurality of currencies.

11. The method of claim 1, wherein at least one of the following benchmarks is used as a bench mark for the currency exchange rates: ECB37, Federal Reserve Bank of New York 10 am Rates (1FED), Federal Reserve Bank of New York 10 am Rates (1FEE), and rates published by the WM Company.

12. The method of claim 1, wherein the optimization algorithm is a mean-variance optimization algorithm.

13. The method of claim 12, wherein the mean-variance algorithm comprises one or more constraints.

14. The method of claim 13, wherein the one or more constraints comprise a predetermined target volatility.

15. The method of claim 14, wherein the target volatility is 5%.

16. The method of claim 14, wherein the target volatility is 1%.

17. The method of claim 14, wherein the target volatility is 10%.

18. The method of claim 14, wherein the target volatility is within a range of 0% to 30%.

19. The method of claim 14, wherein the adjusting step comprises maximizing expected return based on the target volatility using the optimization algorithm.

20. The method of claim 13, wherein the one or more constraints comprise a predetermined target return.

21. The method of claim 20, wherein the target return is within a range of 0% to 20%.

22. The method of claim 20, wherein the adjusting step comprises minimizing expected volatility based on the target return using the optimization algorithm.

23. The method of claim 20, wherein the predetermined target return is based on one or more of the following: 12-month LIBOR rates, 1-month LIBOR rates, 3-month LIBOR rates, 6-month LIBOR rates, 1-week LIBOR rates, and any officially published interest rate for that currency.

24. The method of claim 13, wherein the one or more constraints comprise a variance-covariance matrix.

25. The method of claim 24, wherein the variance-covariance matrix is calculated using historical data.

26. The method of claim 25, wherein the historical data is historical periodic log-returns for each of the one or more currencies over a rolling periodic window.

27. The method of claim 26, wherein a period for the rolling periodic window is one of the following: a business day, a calendar day, one week, one month, three months, six months, one year, 18 months, 2 years and 3 years.

28. The method of claim 26, wherein the variance-covariance matrix is calculated using weightings for each periodic log-return that decrease over time with an exponential formula.

29. The method of claim 24, wherein the variance-covariance matrix is calculated using a GARCH (Generalized AutoRegressive Conditional Heteroskedasticity) model.

30. The method of claim 24, wherein the variance-covariance matrix is calculated using volatilities implied by quoted relative options.

31. The method of claim 1, wherein the step of adjusting is performed on a periodic basis.

32. The method of claim 31, wherein the periodic basis is at least once a month.

33. The method of claim 31, wherein the periodic basis is at least once a week.

34. The method of claim 31, wherein the periodic basis is at least once a year.

35. The method of claim 1, wherein the one or more currencies are selected from a group consisting of United States Dollars, Euros, Japanese Yen, Canadian Dollars, Swiss Francs, British Pounds, Australian Dollars, New Zealand Dollars, Norwegian Krone and Swedish Krona.

36. The method of claim 1, wherein the step of retrieving comprises selecting at least one of the one or more currencies for retrieval based on specific criteria.

37. The method of claim 36, wherein the specific criteria is at least one of the following: potential for investment, geographical location, deliverability, and whether the currency is free-floating.

38. The method of claim 37, wherein the specific criteria is potential for investment, the potential for investment being based on liquidity of the at least one of the one or more currencies.

39. The method of claim 1, wherein the one or more currencies are investable assets.

40. A method of calculating a foreign exchange index comprising:
selecting one or more currencies for inclusion in the index;
selecting a benchmark for the index;
applying an overlay allocation to the benchmark, the overlay allocation being based on adjusting long positions and short positions in the one or more currencies based on an optimization algorithm; and
generating the index based on the results of the applying step.

41. A financial product that uses a foreign exchange index as one of one or more benchmarks, the index being calculated using a method comprising the steps of:
retrieving currency exchange rates corresponding to one or more currencies;
adjusting long positions and short positions in the one or more currencies based on an optimization algorithm; and
generating the index based on the results of the adjusting step.

42. The financial product of claim 41, wherein the financial product is a fund.

43. The financial product of claim 42, wherein the fund is exchange traded.

44. The financial product of claim 41, wherein the financial product is a note.

45. The financial product of claim 44, wherein the note is exchange traded.

46. The financial product of claim 41, wherein the financial product is a security.

47. The financial product of claim 41, wherein the financial product is a debt instrument.

48. The financial product of claim 41, where the financial product is an OTC (Over-The-Counter) product.

49. A computer-based system for calculating a foreign exchange index comprising:
a memory that stores data relating to the index;
a computer-readable medium comprising:
a model analyzer that generates a first set of instructions for adjusting long positions and short positions in the one or more currencies based on an optimization algorithm using currency exchange rates corresponding to the one or more currencies; and
an index calculator that generates a second set of instructions for generating the index based on the adjustment performed by the model analyzer; and
a processor that executes the first and second set of instructions.

50. A computer readable medium having instruction executable on a computer processor for performing a method for calculating a foreign exchange index, the method comprising the steps of:
retrieving currency exchange rates corresponding to a plurality of currencies;
adjusting long positions and short positions in the plurality of currencies based on an optimization algorithm; and
generating the index based on the results of the adjusting step.

51. The computer readable medium of claim 50, wherein the step of adjusting comprises assigning weights to the plurality of currencies based on the optimization algorithm, where each weight represents a position taken in a corresponding currency.

52. The computer readable medium of claim 51, wherein a positive weight signifies an investment and a negative weight signifies a borrowing.

53. The computer readable medium of claim 51, wherein the weights are within a range of +100% to −100%.

54. The computer readable medium of claim 52, wherein the sum of all positive weights is less than or equal to 100%.

55. The computer readable medium of claim 52, wherein the sum of all positive weights is less than or equal to 200%.

56. The computer readable medium of claim 52, wherein the sum of all positive weights is less than or equal to 50%.

57. The computer readable medium of claim 52, wherein the sum of all positive weights is unlimited.

58. The computer readable medium of claim 50, wherein the generated index is expressed in one of the plurality of currencies.

59. The computer readable medium of claim 50, wherein the generated index is expressed in a currency that is not one of the plurality of currencies.

60. The computer readable medium of claim 50, wherein at least one of the following benchmarks is used as a bench mark for the currency exchange rates: ECB37, Federal Reserve Bank of New York 10 am Rates (1FED), Federal Reserve Bank of New York 10 am Rates (1FEE), and rates published by the WM Company.

61. The computer readable medium of claim 50, wherein the optimization algorithm is a mean-variance optimization algorithm.

62. The computer readable medium of claim 61, wherein the mean-variance algorithm comprises one or more constraints.

63. The computer readable medium of claim 62, wherein the one or more constraints comprise a predetermined target volatility.

64. The computer readable medium of claim 63, wherein the target volatility is 5%.

65. The computer readable medium of claim 63, wherein the target volatility is 1%.

66. The computer readable medium of claim 63, wherein the target volatility is 10%.

67. The computer readable medium of claim 63, wherein the target volatility is within a range of 0% to 30%.

68. The computer readable medium of claim 63, wherein the adjusting step comprises maximizing expected return based on the target volatility using the optimization algorithm.

69. The computer readable medium of claim 62, wherein the one or more constraints comprise a predetermined target return.

70. The computer readable medium of claim 69, wherein the target return is within a range of 0% to 20%.

71. The computer readable medium of claim 69, wherein the adjusting step comprises minimizing expected volatility based on the target return using the optimization algorithm.

72. The computer readable medium of claim 69, wherein the predetermined target return is based on one or more of the following: 12-month LIBOR rates, 1-month LIBOR rates, 3-month LIBOR rates, 6-month LIBOR rates, 1-week LIBOR rates, and any officially published interest rate for that currency.

73. The computer readable medium of claim 62, wherein the one or more constraints comprise a variance-covariance matrix.

74. The computer readable medium of claim 73, wherein the variance-covariance matrix is calculated using historical data.

75. The computer readable medium of claim 74, wherein the historical data is historical periodic log-returns for each of the one or more currencies over a rolling periodic window.

76. The computer readable medium of claim 75, wherein a period for the rolling periodic window is one of the following: a business day, a calendar day, one week, one month, three months, six months, one year, 18 months, 2 years and 3 years.

77. The computer readable medium of claim 75, wherein the variance-covariance matrix is calculated using weightings for each periodic log-return that decrease over time with an exponential formula.

78. The computer readable medium of claim 73, wherein the variance-covariance matrix is calculated using a GARCH (Generalized AutoRegressive Conditional Heteroskedasticity) model.

79. The computer readable medium of claim 73, wherein the variance-covariance matrix is calculated using volatilities implied by quoted relative options.

80. The computer readable medium of claim 50, wherein the step of adjusting is performed on a periodic basis.

81. The computer readable medium of claim 80, wherein the periodic basis is at least once a month.

82. The computer readable medium of claim 80, wherein the periodic basis is at least once a week.

83. The computer readable medium of claim 80, wherein the periodic basis is at least once a year.

84. The computer readable medium of claim 50, wherein the one or more currencies are selected from a group consisting of United States Dollars, Euros, Japanese Yen, Canadian Dollars, Swiss Francs, British Pounds, Australian Dollars, New Zealand Dollars, Norwegian Krone and Swedish Krona.

85. The computer readable medium of claim 50, wherein the step of retrieving comprises selecting at least one of the one or more currencies for retrieval based on specific criteria.

86. The computer readable medium of claim 85, wherein the specific criteria is at least one of the following: potential for investment, geographical location, deliverability, and whether the currency is free-floating.

87. The computer readable medium of claim 86, wherein the specific criteria is potential for investment, the potential for investment being based on liquidity of the at least one of the one or more currencies.

88. The computer readable medium of claim 50, wherein the one or more currencies are investable assets.
